(19) United States
(12) Patent Application Publication
(10) Pub. No.: US 2007/0083393 A1
(43) Pub. Date: Apr. 12, 2007

(54) Portable record in electronic form

(76) Inventor: Michael Howell, Columbus, OH (US)

Correspondence Address: Michael Howell;Med Connect Health System, LLC, 4859 Whisper Cove Court, Gahanna, OH, 43230, US

(21) Appl. No.: 11/246,647

(22) Filed: Oct. 6, 2005

(51) Int. Cl. G06F 19/00; G06F 17/00

(52) U.S. Cl. 705/3; 715/500

(57) ABSTRACT

A system and method of creating and updating a mobile record accessible by a user and authorized providers is described.

### FIELD OF THE INVENTION

The present invention relates generally to systems, methods, and computer products for information capture, management, and archiving, and specifically to systems and processes by which portable electronic records may be created, accessed and modified.

### BACKGROUND OF THE INVENTION

Recorded information is necessary for repeat interactions, such as interactions with health care providers. A medical record is maintained for each patient to provide accurate and complete information on treatment and care. The record is the principle means of communication between the physician and other health care providers and serves as the basis for planning the course of treatment. Typically, a medical record includes the medical history, results of examinations, diagnosis, orders and reports for laboratory, radiographic studies, consultation reports, clinical observations, medications ordered and relevant history related to a visit to a physician. The record gives documentary evidence on the course of the medical evaluation, treatment and any changes in condition. Medical records may include interactions for medical services, immunizations, physical therapy, and the like. Medical records include the following information typically collected at each clinical encounter: history of present illness, past illness history, medical history, substance-related history, medications list, allergies list, social history, family history, review of systems, physical exam, laboratory values, ECG, imaging data, mental status exam and progress notes. Counseling and psychological services records may be kept with the primary record or in a separate location for privacy related issues.

Each interaction that a patient has with a new health care provider typically requires a recreation of the record, requiring the patient to repeat the same information multiple times. Often, patients do not remember or cannot provide details of the care they have received. A single medical record that is accessible by any health care provider interacting with a patient that offers a one-time provision of contact information, insurance information, and medical history is desirable.

Physical paper records have inadequacies. Access to the information is not easy because the paper record may be located separately from the person wishing to access the information in the file. Society is increasingly mobile, requiring duplication of efforts each time a new document is produced at a new facility. Paper records are not easily shared. In the case of a medical record, physical records are generally incompatible with emergency care. Critical information is usually not available immediately and significant delays occur where a patient is unconscious or unable to provide background information. Paper records are easily damaged, lost or misfiled. Paper documents may be handwritten and difficult to read or interpret, resulting in errors. Paper records are also difficult to update. Storage space for physical paper records increases the cost of the service.

A method of transferring paper record to an electronic form is through the use of Extensible Markup Language (XML). XML is a computer markup language for documents containing structured information. Structured information contains both content (words, pictures, etc.) and some indication of what role that content plays. XML defines a standard way to add markup to documents and is useful in e-commerce transactions, metadata storage, and the like. In metadata storage, XML is used to identify structures in a document's structure and to provide a schema to define the metadata.

Electronic records are known in the art. Electronic records are data in a form that can be read and processed by a computer. Electronic records may include data files and databases, machine readable indexes, word processing files, electronic spreadsheets, electronic mail and messages, as well as other text or numeric information. Electronic records consist of magnetic tapes and disks, optical disks, compact disks (CD), and any other form of magnetic, electronic, or digital media and their associated software programs, documentation, manuals or instructions.

One type of electronic record is a flash drive. A flash drive is a solid state read-and-write device that attaches to a computer. Flash drives come in many forms and commonly attach via a Universal Serial Bus (USB) port. Flash drives are active only when powered by a USB computer connection and require no other external power source or battery power source. To access the data stored in a flash drive, the flash drive must be connected to a computer, either by direct connection to the computer's USB port or via a USB hub.

Electronic records are generally easy to access and decrease the problem of duplication. In the case of medical records, electronic records allow online referrals, outpatient bookings, transfer of discharge information, and faster access to test results. Electronic medical records allow providers access to information to administer appropriate treatment as quickly as possible in an emergency. Electronic medical records enhance decision making by including up-to-date test records, alerts and reminders. Electronic records are difficult to damage or misfile. In the case of medical records, electronic medical records must conform to state and federal statutes, which include those that protect a patient's record from third party access.

A single, shared medical record provides a more complete picture of a patient's medical history resulting in less duplication and problems for patients in accessing different health care providers. Providers may reference all of a patient's vital statistics, test results, medications, allergies and prior health conditions. Understanding the full scope of a patient's current and past care helps providers in the diagnosis and treatment of a condition or illness.

Patients often have to remember to provide pre-op test results to a hospital prior to surgery. Patients treated at a hospital and then seen at a clinic or doctor's office for a follow-up visit often must remember to bring information with them. A single, easily accessible and updateable patient record that enables health care providers immediate access to a patient's complete medical history is desired.

A patient with a potential drug or allergy interaction may not be conscious to relay that information to a care giver to allow medication administration in an emergency situation. A system that automatically provides a patient's allergies and current medications to a health care provider would decrease unwanted reactions and make decisions concerning new prescriptions easier.

Advance medical directives are documents that outline medical care to speak for an individual should that individual become incapacitated. In these documents, such as a durable power of attorney for health care and living will, the individual decides whether or not to accept treatment in certain conditions or whether to name another to make the decisions. A problem exists with a medical care giver accessing these documents should the individual be incapacitated. The individual may have given a copy to his/her doctor or close relatives, but most times these documents are not readily available. Advance medical directive information that is accessible by medical care providers in an emergency or when an individual is incapacitated is needed.

### SUMMARY OF THE INVENTION

Disclosed herein is a method and system for creating and updating an electronic mobile record containing user information accessible by the user and authorized providers. The mobile record is located on a portable electronic storage device. The method comprises the steps of creating the mobile record by populating the record with at least one fact, associating a mobile record identifier with the mobile record; associating a mobile record access code with the mobile record, said access code required to access the mobile record; distributing the access code to the authorized providers; providing access to the mobile record to authorized providers; and updating one or more fact inputted to the record by one of the user and the provider.

The system is associated with a network. The network is optionally the Internet and the information/fact is optionally formatted using an XML format. Where the authorized providers use a format that is not XML, the processor translates the foreign format into an XML format.

In an embodiment, at least one fact is medical information related to the user and the authorized providers are a healthcare system, a physician's office, medical emergency personnel, and the like. Using the access code, an authorized provider can access the record while the user is incapacitated.

In an embodiment, a user access the network and creates the record to be stored on the device. The system creates the access code associated with the mobile record that allows the user and authorized providers to access, input, update and export facts stored in the mobile record. When the device is outside of the network, the record may be updated. When the device is again linked to the network, the system compares the record to a file associated with the user stored a database and updates the file based on the comparison. The file is associated with the mobile record and accessible by authorized providers. The update may be automatic or be based on a prior review authorization.

In an embodiment, information, such as insurance information, demographic information, personal information, medical history information, physician contact information, donor information, appointment information, therapy management information, emergency contact information, and the like are stored in the record. The invention transfers facts to and from other systems linked to the network to and from the record. The invention comprises the ability to print a paper version of a medical card, an insurance card, a donor card, a provider card, an emergency contact card, a living will, a healthcare power of attorney, and the like from the facts.

The system comprises a portable device that houses the mobile record, a processor linked to a network, a database linked to the network that houses files of users correspond to user records, and may include other components, such as printers, CPUs, other portable media, links to other networks, and the like.

### BRIEF DESCRIPTION OF THE DRAWINGS

FIG. 1 is a schematic of the system of the present invention showing the interaction of the components.

FIG. 2 is a screen print of a web page depicting an embodiment of the present invention.

FIG. 3 is a screen print of a web page depicting an embodiment having an interactive site for a user to input access data.

FIG. 4 is a screen print of a web page of an embodiment depicting an interactive site for a user to input personal information.

FIG. 5 is a screen print of a web page of an embodiment depicting an interactive site for a user to input information concerning emergency contact information.

FIG. 6 is a screen print of a web page of an embodiment depicting an interactive site for a user to input information concerning medical history.

FIG. 7 is a screen print of a web page of an embodiment depicting an interactive site for a user to input physician information.

FIG. 8 is a screen print of a web page of an embodiment depicting an interactive site for a user to input insurance information.

FIG. 9 is a screen print of a web page of an embodiment depicting an interactive site for a user to review the inputted information and print cards.

FIG. 10 is a screen print of a web page of an embodiment depicting a subroutine to prompt users for information to input to the record.

FIG. 11 is a screen print of a web page of an embodiment depicting the steps of the subroutine.

FIG. 12 is a screen print of a web page of an embodiment depicting a step of inputting personal information.

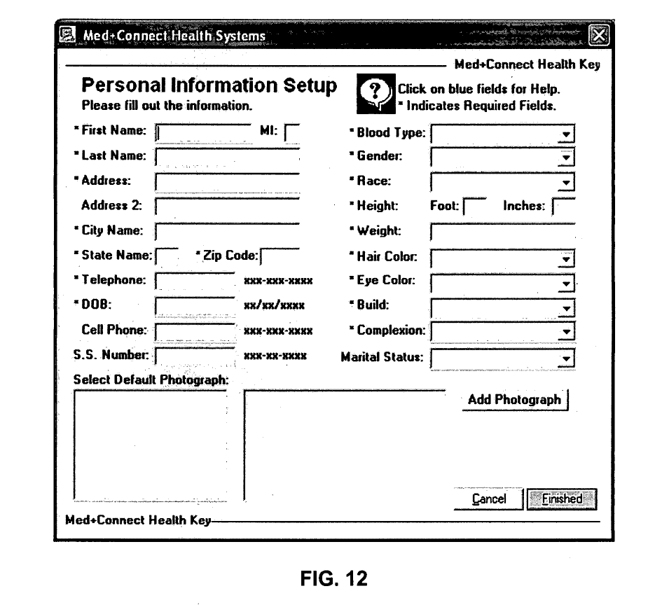

FIG. 13 is a screen print of a web page of an embodiment depicting a step of inputting emergency contact information.

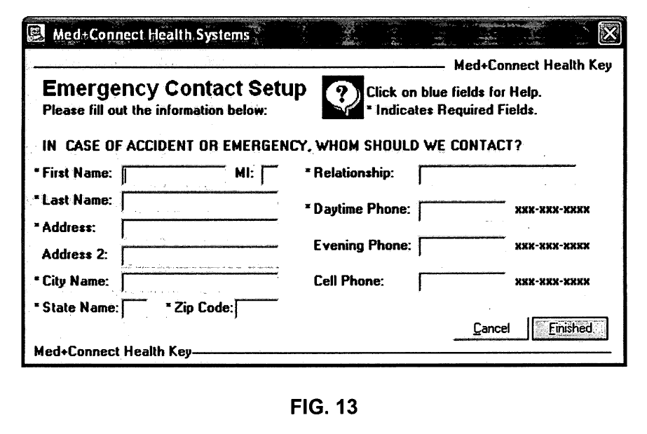

FIG. 14 is a screen print of a web page of an embodiment depicting a step of inputting insurance information.

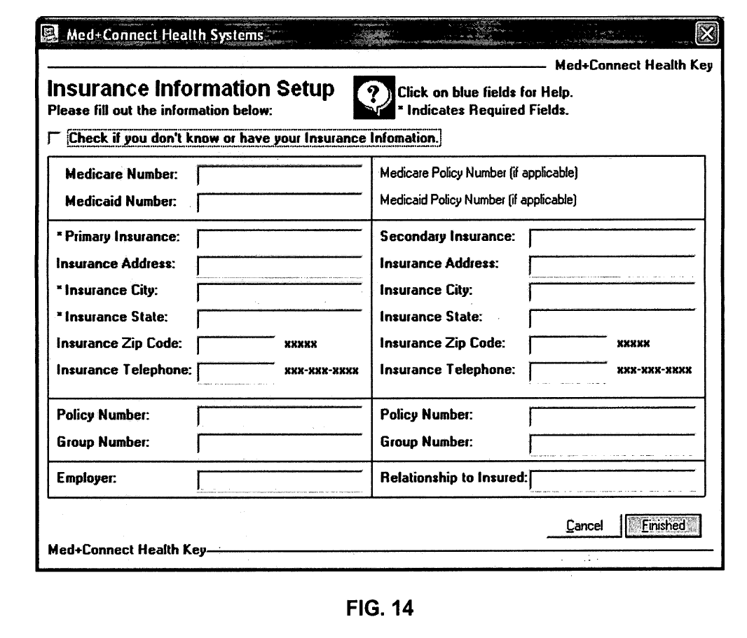

FIG. 15 is a screen print of a web page of an embodiment depicting a step of physician information.

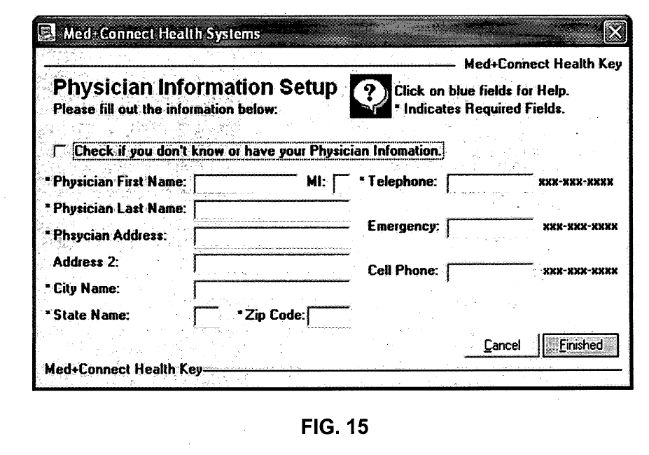

FIG. 16 is a screen print of a web page of an embodiment depicting a step of inputting medical history information.

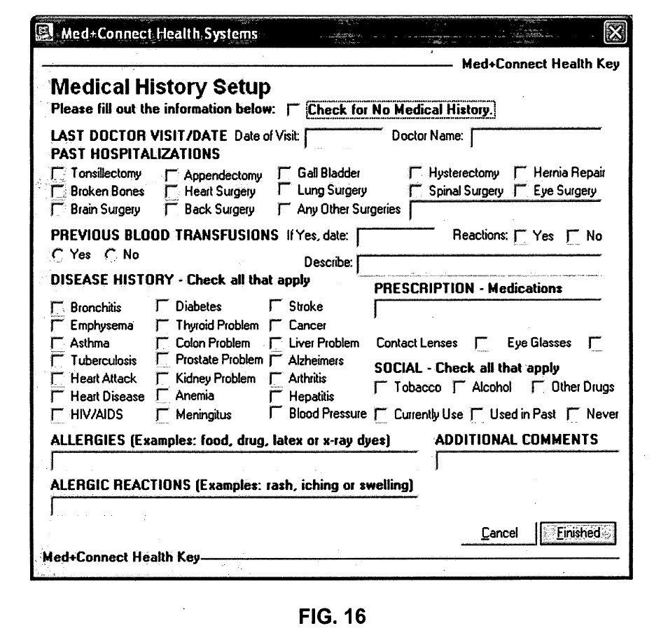

FIG. 17 is a screen print of a web page of an embodiment depicting a prompt to the user to complete all of the steps.

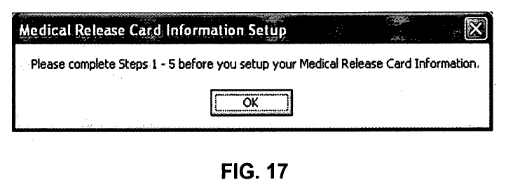

FIG. 18 is a screen print of a web page of an embodiment depicting a first step of initiating the card print function.

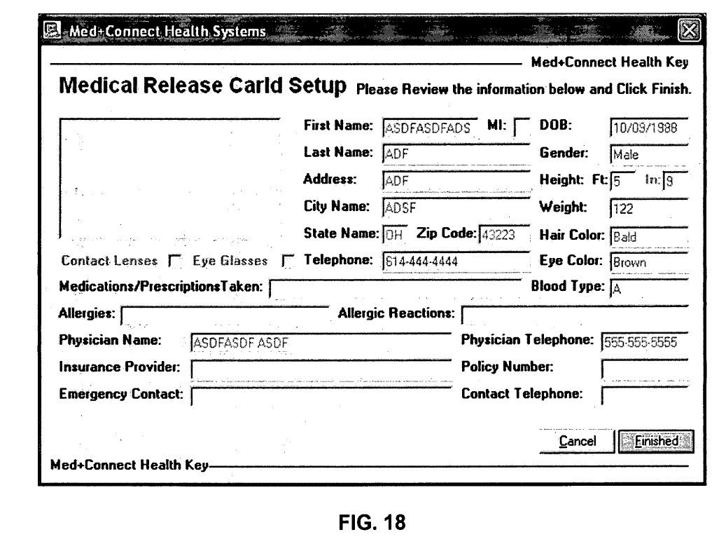

FIG. 19 is a screen print of a web page of an embodiment depicting a second step of initiating the card print function.

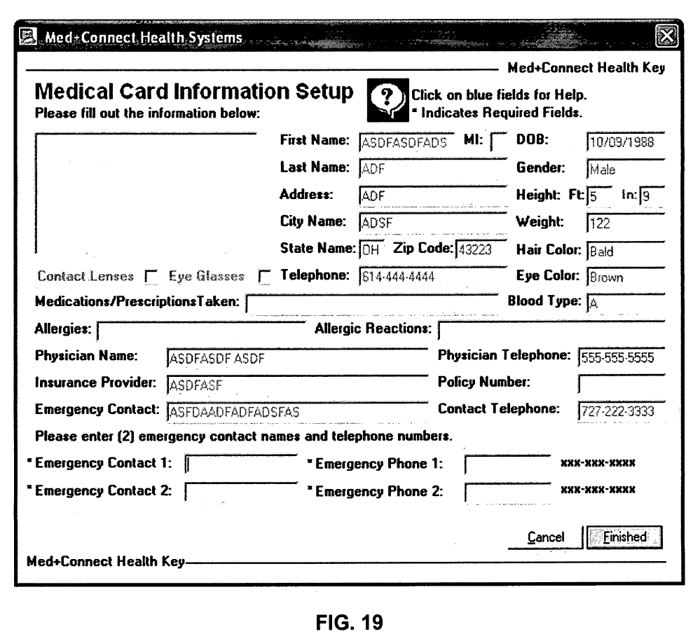

FIG. 20 is a screen print of a web page of an embodiment web page of an embodiment depicting a final step of initiating the card print function.

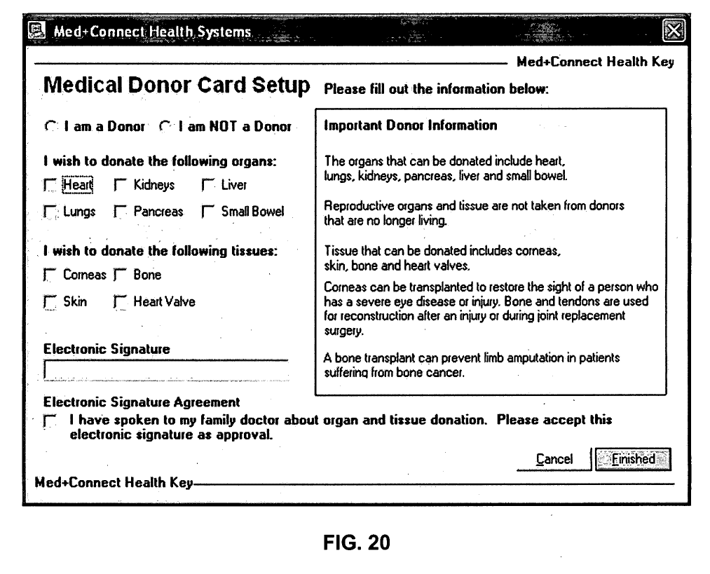

### DETAILED DESCRIPTION OF THE INVENTION

The present invention provides a system that works with existing applications and records to provide secure access to information about a user electronically. The system, which is capable of communicating in a universal language, comprises importing and exporting data, allowing authorized access to information and updating master files in a database via a network. The present invention is system of using a portable electronic device to house information about a user that is accessible by third parties authorized to access the information. Information housed on the device is synched with a central database operatively linked to the device, wirelessly or directly, in a network, such as an intranet, linked network, the Internet, and the like.

The present invention may be used in any arrangement where information known by a user, such as a client, customer, patient, and the like, is necessary for interaction with a provider. The present invention may be used by a variety of providers and is readily applicable to any regulatory or enforcement provider, such as police, prisons, armed forces, government, border control, universities, airlines, and the like. For brevity this description focuses on medical providers, such as, but not limited to, healthcare systems, pharmacy systems, physicians' offices, other medical provider offices, dental offices, hospitals, day care facilities, nursing homes, outpatient clinics, schools, and the like; however, any type of provider requiring access to information may employ the system.

In an embodiment, the system is used for medical record access. For example purposes, the following embodiment including a healthcare system and a physician's practice interacting with a patient will now be discussed. In an embodiment, the medical record comprises personal, medical and related information about a user or patient.

The patient presents at either the physician's office or a component of the healthcare system such as, but not limited to, a hospital, clinic, outpatient facility and the like, where medical information typically collected for billing, identification, notification, reporting, statistical, ordering, and other purposes, is collected. Alternatively, the patient may provide the information without interacting with the office or the healthcare system from any point connected to the network, including but not limited a personal computer.

In an embodiment, the information is inputted into the system using a computer terminal. In an alternate embodiment, the information is colleted from existing systems electronically. The information is imputed into templates or fields and may include pre-populated selectable fields as know in the art, or the input may be customized. The information may be text format, image format, audio format, a combination of formats, and the like.

In an embodiment, the information comprises facts related to billing, demographics, medical history, and the like. In an embodiment, the information comprises personal or demographic information, billing and insurance information, medical history information, physician contact information, emergency contact information, donor information, and the like.

In an embodiment, personal information comprises full name, address, telephone number(s), date of birth, social security number, nationality, blood type, gender, race, height and weight, hair color, eye color, build, complexion, marital status, scars, donor information, voice print, finger print, retinal print, photographs, licenses, occupation, countries visited, language, spouse, children, drivers' license number, last update, identifier of updates, and the like.

In an embodiment, the insurance information comprises primary insurer, primary insurer address, telephone number(s), primary insurer policy holder, employer and patient's relationship to the holder, policy number and group number, and the like. The insurance information further comprises fields to input the above information for secondary or other insurance providers. The insurance information further comprises Medicare and or Medicaid number fields, last update date and the identifier of the updates.

In an embodiment, the medical history information comprises date last updated and the identifier of the updates, date of last visit to a physician and the physician's name/practice name and/or address, past hospitalizations, date and cause, past surgeries, date and cause, allergies, drug allergies, allergic reaction history, blood transfusions, prescriptions and dosages, disease history, life style, family medical history, immunizations and dates, dental history, present conditions and the like. Life style information comprises information such as tobacco, drug, alcohol use, and other types of environmental health factors, corrective lens prescription and whether a contact wearer and date of last eye exam, dental history, including extractions, bridges, filing, last exam and the like.

In an embodiment, physician information comprises information about dentists, optometrist, specialists and general providers. Physician information comprises full physician name, address, telephone number(s) last update dates and identifier of updates, type of physician, and the like.

The embodiments described herein are network-based and facilitated via computer; however, one skilled in the art will readily realize that the system is adaptable to any now existing or future information storage and transfer system. In an embodiment, the system is provided via an easy to use operating system such as, but not limited to, a Windows® based system. The system uses any language, such as HTML, fortran, and the like. The system of the present invention further comprises an adapter so that a user may use the system with a different language and operating system.

In an embodiment, the system comprises a network. The network may be public or private and may be stand alone or linked to networks. In an embodiment, the network is the Internet. The network may be physically connected via data line, phone line, electric lines, cable lines, and the like or may be wireless connected via short wave, radio, satellite or other transmissions. The system of the present invention comprises a portable electronic information storage device, such as but no limited to, a smart card, scan card, external storage device, data chip, Universal Serial Bus (USB) flash drives, memory disks, chips, and the like, linked to the network. The link may be wireless or physical, such as via a USB coupler.

In an embodiment, the USB flash drive is a compact USB flash memory drive that acts like a portable hard drive, allowing storage and transportation of computer data. In an embodiment, the USB flash drive hold large amounts of information. The storage device may be part of another device, such as but not limited to jewelry, writing instruments, eyeglasses, key fobs, watches, key ring, and the like. In an embodiment, the USB flash drive is adapted to appear as a pendant, cufflink, earring, pen, pencil, ring, watch, card, and the like. Alternatively, the storage device may be implanted beneath the skin of the patient. The portable storage device comprises means to protect and encrypt data. The protection means may be any now known in the art or a future means adaptable to the system.

The system further comprises a database. The database comprises files linked to user/patient and comprises information matching or updateable to match the information in the record located on the user's portable storage device. The database is firewall protected and may be duplicated for backup. The system optionally comprises printers, data transfer devices, and other various computer-type components.

The method of using the system comprises first populating the mobile record stored on the portable device with information about the user. In an embodiment, a user accesses the network to input or download the information. Alternatively, the system may employ any auto-population method to transfer the information to the record on the portable device.

An identifier is assigned to the information. The identifier may be any now known in the art or future means of identification, such as a password, code, biometric, user name, user name password combination, and the like. In an embodiment, the identifier is a medical record number. The identifier is linked to information stored in the mobile record and in a file corresponding to the user in the database. In an embodiment, a user may change the identifier. When the user changes the identifier, the system updates the change and provides notice of the change to authorized users to allow access to make changes in the file and the mobile record.

Alternately, the user is provided access only to the mobile record through an identifier that is linked to the file and the mobile record and the provider has the option to review any updates made to the mobile record prior to any updating of the file.

The information is entered or auto-populated (which may be from the information in the file and or from other sources) and saved in the mobile record on the portable storage device. Where the population of the mobile record is performed in the network, the mobile record information is synched with the information in the file in the database. If the population occurs when the device is not connected to the network the information is synched to the file the next time the device accesses the network.

In an embodiment, the user/patient assigns a key to one or more field associated with information stored in the mobile record. The field is determined by the user and may be limited as to type of information, or as to a specific within a type of information such as personal information, such as social security number. The system links the key to the fields and to the file in the database. When the user interacts with a provider, the user provides the one or more key to the provider. The provider uses the key to access the key-linked information stored in the record located on the personal storage device. The key allows limitation to access for use in the interaction, which may be routine medical treatment, etc. In an alternate embodiment, the user does not provide a provider the key, but the key is a universal key that allows access by specified providers, such as emergency care providers in situations where the patient is unconscious, incapacitated, and the like.

The user may update information in the record stored on the portable device and database, or, the provider may be the only authorized updater, for use in scenarios where the user may not have access to a computer, is not capable of updating, or is prevented from access, such as use by a corrections facility provider and user prisoners. A provider having a key may update the key-associated information stored in the record on the portable device. The updated record information will be compared to the information contained in the users file when the device is linked to the network and the file information updated.

When the user and or a provider possessing the identifier/key updates any field, the update date is recorded and a tab associated with the update is collated for audit trail purposes. The information may be updated using any device capable of accessing the network, including but not limited to a wireless device, laptop, personal computer and the like.

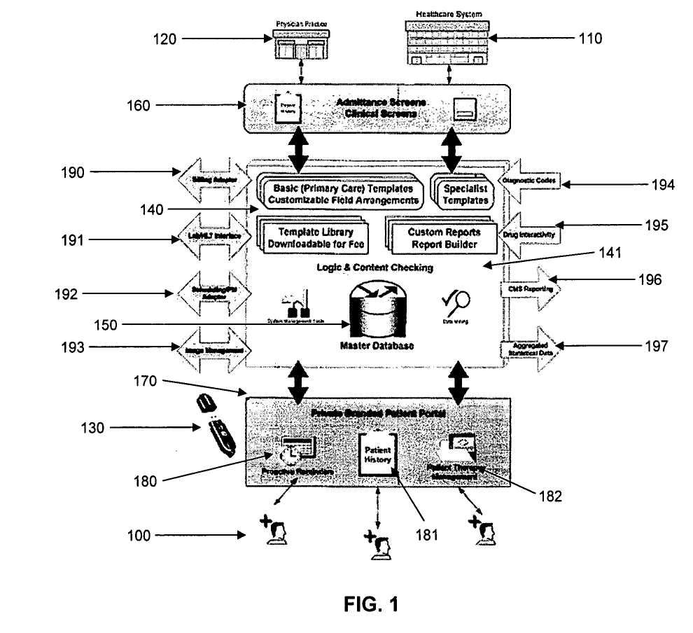

The system may be used by a provider to determine information in the aggregate and to perform statistical analyses. As examples in the health care embodiment, a pharmacy may aggregate drug prescription information or pharmaceutical companies; a laboratory may provide statistics as to average blood glucoses by area to a physician or clinic; a physician may provide clinical trial information to medical device or drug supplier, etc. The system of the invention is an electronic system that allows authorized users to access information from a mobile record. In an embodiment depicted in FIG. 1, the system is accessed by a user/patient 100, a provider comprising a health care system 110, and affiliates of the health care system, such as a physician's practice 120. After the mobile record is created using templates 140 of the system and stored on a portable device 130, the system stores the information in a file in a central database 150. Alternatively, the record may be populated using information from the file associated with the user 100. Either the provider 110, 120 or the user 100 may update the record stored on the device 130. The provider 110, 120 accesses the network to update the record stored on the device 130 for any care 160 provided to the user 100. The user 100 accesses the record to input and update information 170 to the record stored on the device 130. In addition to the information described below 181, the information may comprise reminders of appointments 180, patient therapy management 182 and the like.

The device 130 optionally comprises an alarm. The alarm is activated by a fact in the information corresponding to a predetermined trigger stored in the record, such as but not limited to, a reminder of an appointment.

The system comprises components, such as processor 141 for managing data, a database 150 for data storage, input and viewing devices, output devices, and the like. As depicted in FIG. 1, the system provides and accepts data 190-197 including but not limited to data related to scheduling, billing, lab results and other test information, including images. In an embodiment, the system employs HL7, the industry standard protocol for transferring medical data. The system includes preventive maintenance scheduling and components for image management. The system provides content management system (CMS) reporting of organization and creation of files stored on the database.

In an embodiment, the system uses XML markup language to identify structures in a record and to provide a schema to define the facts and the information.

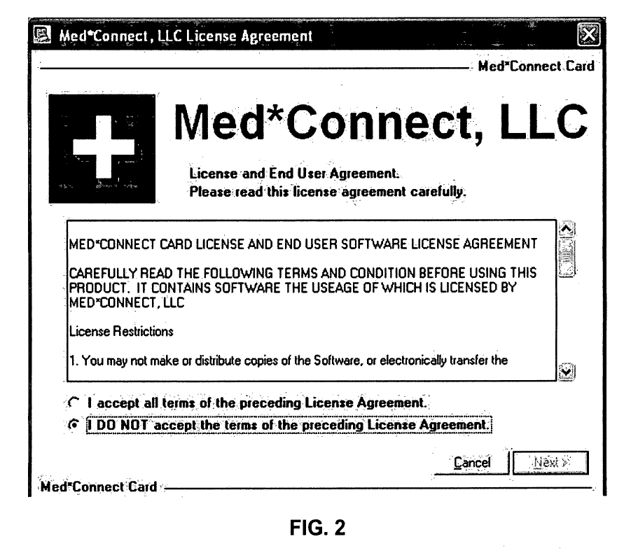

In an embodiment depicted in FIG. 2, the system is accessible via an Internet web site having an assigned address.

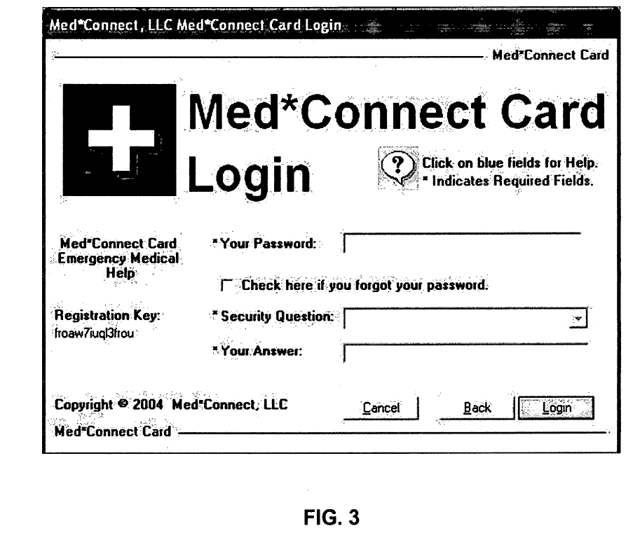

In the embodiment depicted in FIG. 3, a user is assigned an identifier, such as a password, to access the Internet web pages of the system. The identifier is linked to a file stored in a database 150 on the system and to the mobile record stored on the portable device 130. Via the present invention, upon the successful input of an identifier/password known to the system, a user 100 accesses interactive screens of the system to create, update and view information stored in the file and in the mobile record. The screens are customized based on the requirements of the user/customer. In an embodiment, the screens are templates for inputting information such as, but not limited to, basic and primary care fields, specialists, reports, and the like. The system accesses information outside of the system, such as diagnostic codes, drug interactivity, and the like, and populates designated fields within the chosen templates 140.

In an embodiment, the system creates a record stored on a portable device 130. In an embodiment depicted in FIGS. 2-9, the record comprises a patient history 181 of a user 100 associated with a health care system 110, appointment reminders 180, and therapy management 182. The patient history comprises related information, such as insurance, health care and contact information and may comprise donor information and living will directives. The system captures data for record creation, access, updates, and deletions.

The user (or a third party authorized by the user), access a portal to access the system to populate and or update the record. Access may be in the network, or outside of the network. In an embodiment depicted in FIG. 2, the portal is an Internet website constructed to capture user information. As depicted in FIG. 3, access to the system is password-protected and provides security audit data for access, inputted information and updates. The system provides security through security policy definitions, secured object definitions, role definitions, user definitions, and the relationships among them, based on events, log-ins, data access, and updates. An audit record of access is retained by the system, recording identification and authentication of each access, the data accessed, the functions used to access the data, and data imported/exported. The system provides means to compile and view audit record reports.

The system assigns an identifier, such as a medical record number to the user 100 and opens a file. The file is linked to the identifier and the password (which may be the same or different). After accessing the system, the user 100 enters information into predefined fields. The information is stored in the mobile record and or in the file. In an embodiment, the user 100 inputs information via individual interactive web pages linked by hyperlinks. The information includes but is not limited to personal information, medical history information, insurance information, emergency contact information, physician information, and the like.

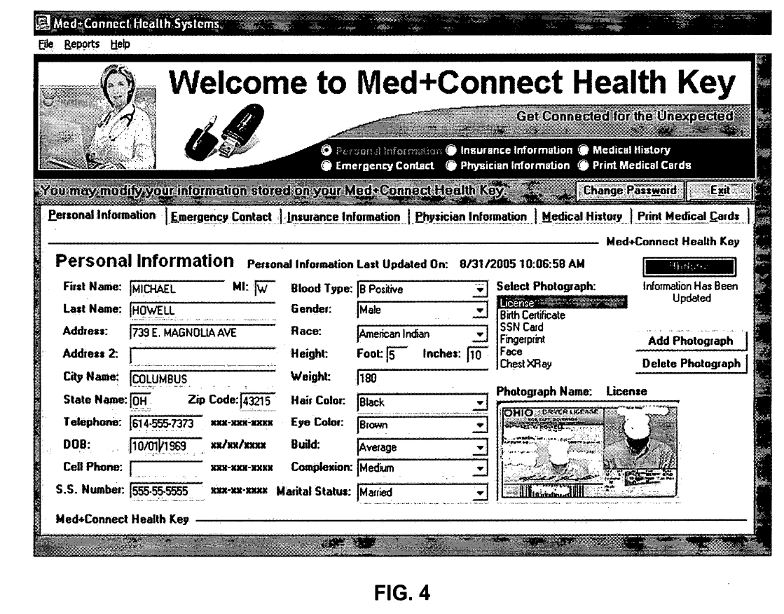

In an embodiment depicted in FIG. 4, the information comprises personal information, including but not limited to name, address, phone numbers, date of birth, social security number, blood type, gender, race, height, weight, hair and eye color, build, complexion, marital status, and the like of the user 100. Personal information further comprises images and other data files, such as but not limited to a birth certificate, bio-identifier, such as a voice print, iris scan, fingerprint and the like, a license, an image of the user and the like.

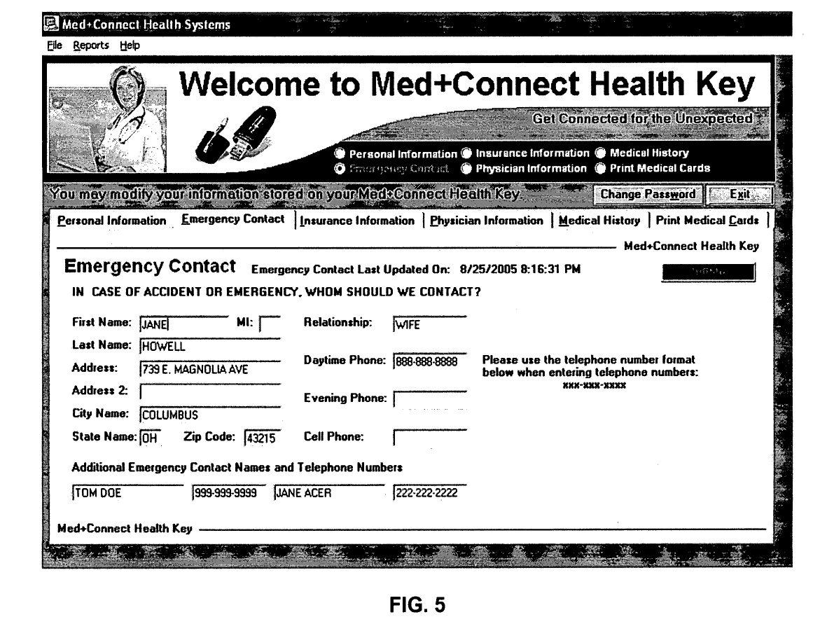

In an embodiment depicted in FIG. 5, the information comprises emergency contact information, including but not limited to name, address, relationship, phone numbers, and the like of a person or persons designated by the user 100 to be contacted in an emergency.

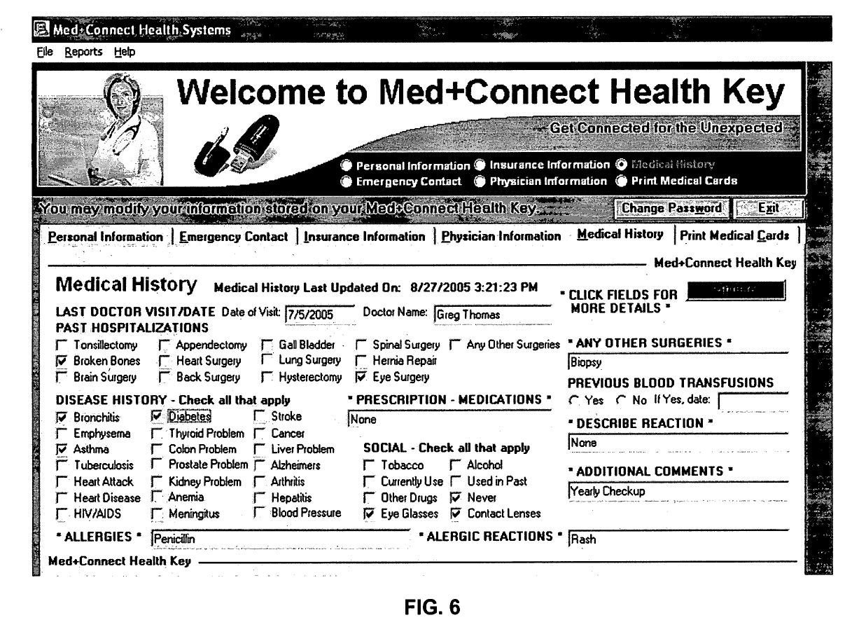

In an embodiment depicted in FIG. 6, the information comprises a medical history. In an embodiment, a healthcare system 110 creates a template that a user/patient 100 accesses to input date of last physician visit and name, and review and select past hospitalizations for conditions such as tonsillectomy, broken bones, brain surgery, appendectomy, heart surgery, back surgery, gall bladder problems, lung surgery, hysterectomy, spinal surgery, hernia surgery, eye surgery and the like. In an embodiment, a field is included to manually input the type of condition for which the user 100 was hospitalized.

In an embodiment, medical history comprises a disease history of the user 100, including but not limited to diseases such as bronchitis, emphysema, asthma, prostate problems, meningitis, stroke, liver problems, Alzheimer's, hepatitis, blood disorders, breast disease, cancer or malignancy, cerebral palsy, chicken pox, chronic bronchitis/emphysema, chronic inflammatory bowel disease (Crohn's, ulcerative colitis), chronic kidney condition, depression, diabetes mellitus, digestive trouble, dizziness/fainting, ear infections/hearing problems, eating disorders: bulimia/anorexia nervosa, emotional/mental illness; fracture/sprains, hay fever, hepatitis, heart disease, high cholesterol, HIV/AIDS, insomnia/sleep problems, kidney disease (congenital or other), menstrual problems, migraine/recurrent headaches, orthopedic problems/injuries, pelvic infection, peptic ulcer, phlebitis, pregnancy, rheumatic fever, seizure disorder (epilepsy), sexually transmitted disease, skin disorder, systemic lupus, thyroid disorder, tuberculosis or past positive tuberculin skin test, urinary infection, and the like. In an embodiment, a field is included to manually input the type of condition a user 100 may have experienced or is experiencing.

In an embodiment, medical history further comprises social impact information such as but not limited to tobacco and alcohol use, drug use, prescription lenses, and the like. A user 100 is prompted to input information regarding blood transfusions, reactions, allergies and any reactions, and the like. In an embodiment, a field is included to manually input additional comments.

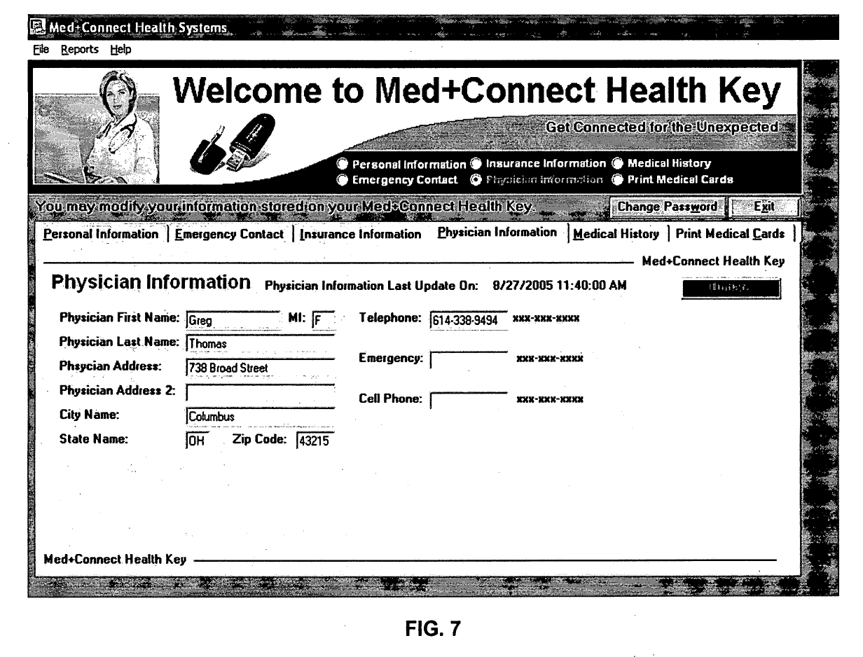

In an embodiment depicted in FIG. 7, the information comprises physician information, including but not limited to name, address, phone numbers, and the like of a physician associated with the user 100. Multiple physicians may be designated. Physicians may include other healthcare providers, dentists, physical therapists, specialists, chiropractors, and the like.

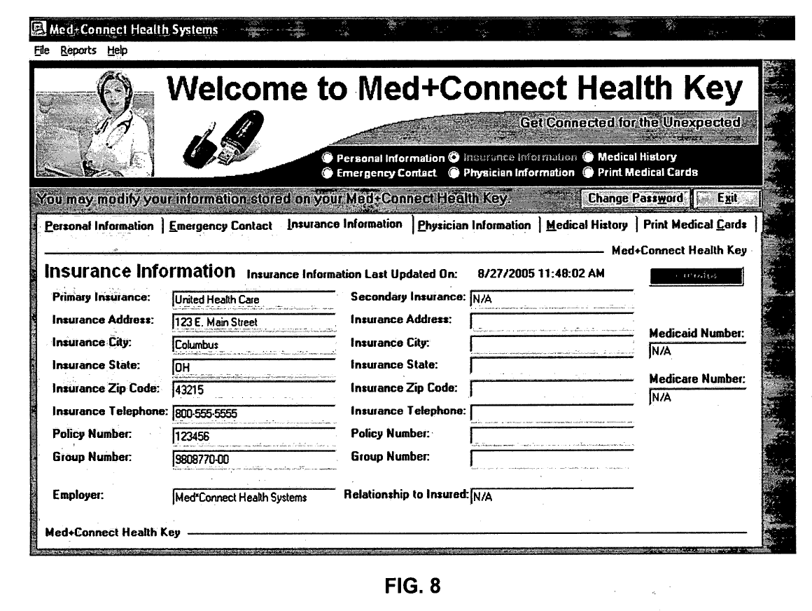

In an embodiment depicted in FIG. 8, the information comprises insurance information, including but not limited to name, address, and phone numbers, policy numbers, group numbers, employer, and insured relationship for primary and secondary insurers, Medicare/Medicaid numbers, and the like associated with the user 100. Multiple insurers may be designated.

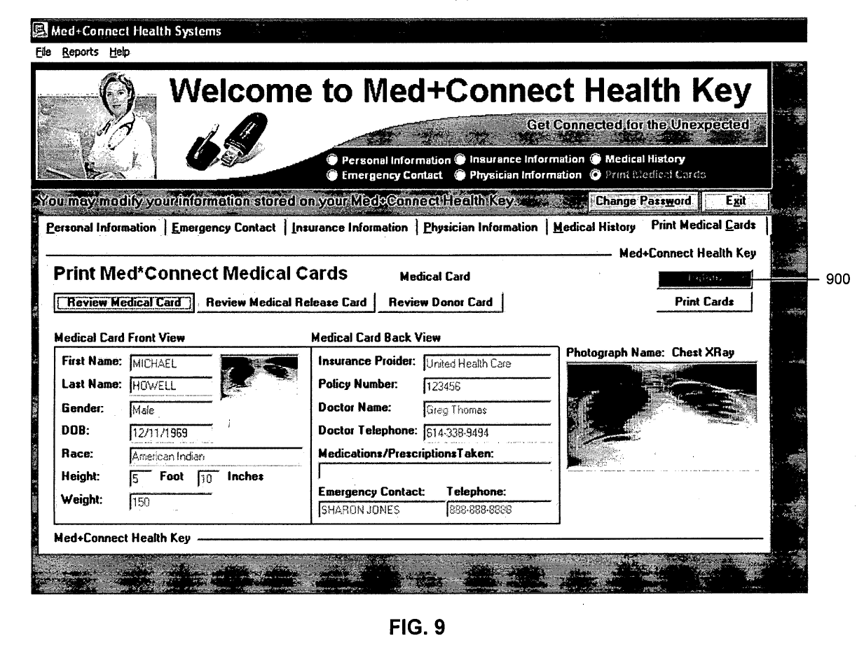

In an embodiment, the information may be updated. In an embodiment depicted in FIG. 9, the information is updated by accessing an interactive website, deleting and reentering the information to be updated in a selected field, and performing an operation to activate a subsystem to perform the update, such as “clicking” on a hyperlink to the sub-function, depicted in the figures as the update button 900.

In an embodiment, after a user 100 inputs the desired information, the system displays a review and print component. In an embodiment, the information is reviewed and verified. In an embodiment comprising a printing means, the user prompts the system to populate a template comprising a card. More than one card may be printed comprising information such as insurance, an emergency contact, donor, medical, medical release, advance directives, and the like. The user 100 reviews the information and initiates the function in the system to print the card.

In an embodiment, the information inputted into the file is stored on a mobile record on a portable device. In an embodiment, the device is a USB flash drive. The flash drive comprises permissions to create, modify, delete, query and or display the information stored in the record and or synch the record information to the file information associated with the user that is stored in the database. The file is stored in a database of files containing other users' information.

In an embodiment, the system's database stores a copy of the inputted information. The database may be central or located in separate local data stores. The collection and storage of data is transformed to a common schema useable by different programs and systems.

The system records access to the record, including successful and unsuccessful attempts from human users and automated system, care data events, and the like. The information stored in the record may be exported to an external source, including printers, screens, other types of portable media, and the like.

In an embodiment, the present invention comprises advance medical directive information. The user inputs facts to the record stored on the device, which is updated to the master file. The information includes whether the user has a living will and or a durable power of attorney and a contact person with a phone number for each. The user inputs information regarding his/her wishes for hospice care. The user inputs information regarding life insurance, including the user's company, agent's name and telephone number.

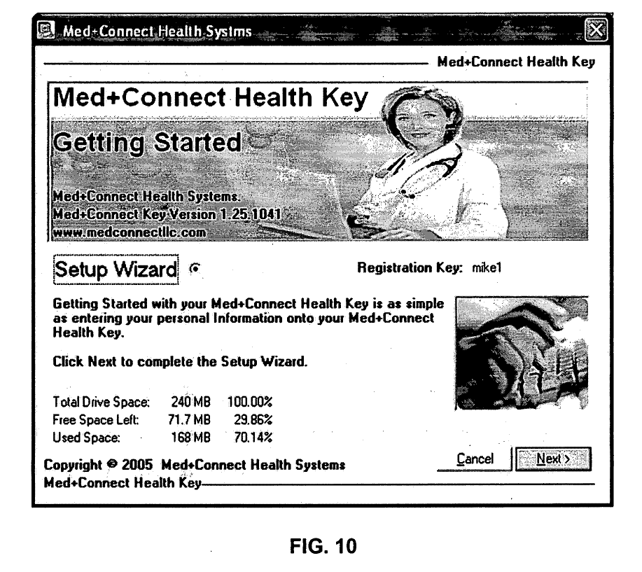

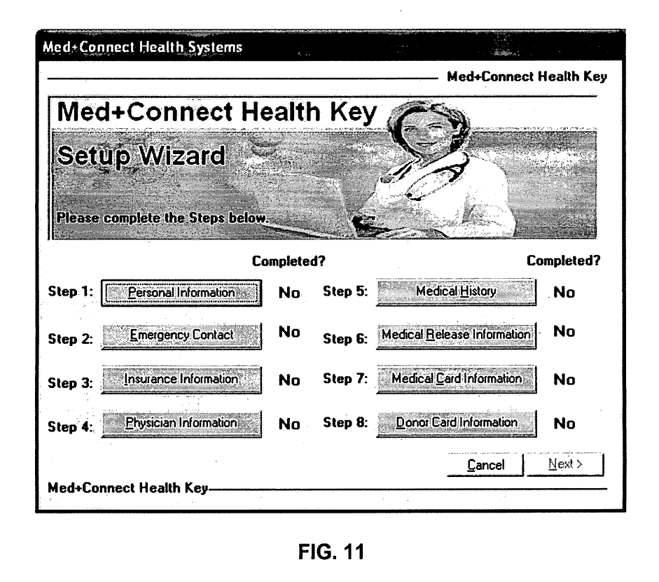

In an embodiment, the invention comprises means to easily populate the file and or the mobile record. In an embodiment depicted in FIG. 10, the means is a computer “setup wizard.” The wizard is a subroutine of steps that create web pages for a user to input information. As depicted in FIG. 11, the steps are related to personal information, emergency contact, insurance information, physician information, medical history, medical release information, medical card information, and donor card information. The wizard presents an interactive web page corresponding to each step. The first step prompts the user to input personal information. The next step prompts the user to input emergency contact information. The next step prompts the user to input insurance information. The next step prompts the user to input physician information. The next step prompts the user to input medical history information. At each step the user is presented a hyperlink to inform the system to continue to the next step if the fields are properly filled in. One or all of the fields may be designated to be acceptable prior to the user continuing to the next step.

After the information is entered, the system prompts the user to input information to prepare one or more card. In an embodiment, the cards are insurance cards, medical alert cards, donor cards, emergency contact cards, and the like. After the information is inputted, the system prompts the user to select the print function and the cards are printed using the information inputted by the user.

In an embodiment, living will information is included on the device. The user inputs information regarding the use of CPR, a respirator, tube feeding, dialysis, and pain management. The user may indicate refusal of all treatment. The user may indicate types of interventions in the case of a sudden complication with or without other sever health problems, such as heart disease or a stroke; a controllable and uncontrollable chronic illness; a deadly illness, where treatment could/could not provide activity and comfort; and an endless coma, either with no other health problems or with a lasting or deadly illness.

The portable device is physically located with the user 100 so that a provider with a key, such as a health system 110, or an unknown provider (such as in an emergency situation), may access information stored in a record on the device in an interaction. Information that results from the interaction is added to the record (and to the file when the record is linked to the network) so that the next time the user 100 interacts with that provider, or a different provider, such as a physician's practice 120, the provider has immediate access to the interaction. In each instance, the provider may be using the system of the network, or may use a foreign system. Where the provider uses a foreign system, the present invention translates the to a format understandable by the network.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

I claim:

1. A method for creating and updating an electronic mobile record of a user accessible by more than one authorized provider comprising:
creating the mobile record by populating the record with at least one fact, said mobile record located on a portable electronic storage device capable of communicating with a processor;
associating a mobile record identifier with the mobile record;
associating a mobile record access code with the mobile record, said access code required to access the mobile record;
distributing the access code to the authorized providers;
providing access to the mobile record to authorized providers; and
updating one or more fact inputted to the record by one of the user and the provider.

2. The method of claim 1 wherein the network is the Internet and the fact is formatted using an XML format.

3. The method of claim 2 wherein the authorized providers access the device using a format that is not XML, said processor translating the not-XML format into an XML format.

4. The method of claim 1, wherein the at least one fact is at least one of medical information related to the user, appointment reminders and therapy management.

5. The method of claim 4 wherein the authorized providers are at least two of a healthcare system, a physician's office and medical emergency personnel.

6. The method of claim 5 wherein the authorized providers access the record while the user is incapacitated.

7. The method of claim 1 comprising the steps of comparing the updated fact to a corresponding original fact contained in a file linked in a network to the device, said file accessible by at least one provider and associated with the mobile record, said comparison to obtain comparison results; and updating the file based on the comparison results.

8. The method of claim 1 comprising printing a paper version of at least one of a medical card, an insurance card, a donor card, a provider card, an emergency contact card, an appointment calendar, a therapy management plan, a living will, and a healthcare power of attorney, comprising information derived from at least one fact via a print component linked to the processor.

9. The method of claim 1 wherein the processor is linked to a network, said processor transferring at least one fact to at least one module linked to the network, said processor receiving data associated with the user from at least one module, said processor uploading the data to the mobile record.

10. The method of claim 1 comprising the step of activating an alarm located on the device; said alarm activated based on at least one fact corresponding to a predetermined trigger stored on the device.

11. The method of claim 1 wherein the at least one fact comprises at least one of insurance information, demographic information, personal information, medical history information, physician contact information, donor information appointment information, therapy management information and emergency contact information.

12. A mobile record access system for use by a user and at least one authorized provider comprising:
a processor linked to a network; and
an electronic portable device linked to the processor, said device housing a mobile record; wherein the processor 1) receives at least one fact, 2) stores the fact in the mobile record, and 3) creates an access code associated with the mobile record, said access code allowing the user and at least one authorized provider to access, input, update and export at least one fact stored in the mobile record.

13. The mobile record access system of claim 12 comprising:
a database linked to the network and accessible by at least one authorized provider; said database comprising a file; said processor comparing at least one fact in the mobile record to an original fact stored in the file and updating the file based on the comparison.

14. The system of claim 12, wherein the record is medical information related to the user and at least one authorized provider accesses the record while the user is incapacitated.

15. The system of claim 12 comprising at least one component, said component at least one of a printer, a CPU, a portable media, and a link to a second network.

16. The system of claim 15 wherein the processor directs the printer to print a paper version of at least one of a medical card, an insurance card, a donor card, a provider card, an emergency contact card, an appointment calendar, a therapy management plan, a living will, and a healthcare power of attorney; said paper version comprising information derived from at least one fact.

17. The system of claim 12 wherein the device is a USB flash drive; said device comprises an alarm.

18. The system of claim 12 wherein the at least one fact comprises at least one of insurance information, demographic information, personal information, medical history information, physician contact information, donor information, appointment information, therapy management information, and emergency contact information.

19. The system of claim 1 wherein the network is the Internet and the fact is formatted using an XML format and at least one authorized provider accesses the device using a format that is not XML, said processor translating the not-XML format into an XML format.

20. A mobile record access system for use by a user and at least one authorized provider comprising:
a processor linked to a network;
an electronic portable device linked to the processor, said device housing a mobile record and comprising an alarm; wherein the processor: 1) receives at least one fact, said fact comprising at least one of insurance information, demographic information, personal information, medical history information, physician contact information, donor information, appointment information, therapy management information, and emergency contact information; 2) stores the fact in the mobile record; and 3) creates an access code associated with the mobile record, said access code allowing the user and at least one authorized provider to access, input, update and export at least one fact stored in the mobile record; wherein if said fact is formatted in a non-XML format, said processor translates the non-XML formatted fact into an XML format;
a database linked to the network and accessible by at least one authorized provider; said database comprising a file; said processor comparing at least one fact in the mobile record to an original fact stored in the file and updating the file based on the comparison; and
at least one component, said component at least one of a printer, a CPU, a portable media, and a link to a second network; wherein the printer prints a paper version of at least one of a medical card, an insurance card, a donor card, a provider card, an emergency contact card, an appointment calendar, a therapy management plan, a living will, and a healthcare power of attorney; said paper version comprising information derived from at least one fact.
